(19) United States
(12) Patent Application Publication
(10) Pub. No.: US 2015/0081407 A1
(43) Pub. Date: Mar. 19, 2015

(54) BUSINESS TRANSACTIONS USING TRUST BASED INSTRUMENT

(71) Applicant: ZenMesh Private Limited, BANGALORE (IN)

(72) Inventors: DEEPA JEETU, BANGALORE (IN); LAKSHMI VARMA P.K., BANGALORE (IN)

(73) Assignee: ZenMesh Private Limited, BANGALORE (IN)

(21) Appl. No.: 14/215,078

(22) Filed: Mar. 17, 2014

(30) Foreign Application Priority Data
Mar. 21, 2013 (IN) 1220/CHE/2013

(51) Int. Cl. G06Q 40/04; G06Q 30/02

(52) U.S. Cl. CPC G06Q 40/04; G06Q 30/0211
USPC 705/14.13

(57) ABSTRACT

The embodiments herein disclose methods and systems for trust based transactions between entities. The method comprises the step of inviting one or more entities to register on the ET platform, allowing one more issuing entities to set campaign and/or contract, distributing and activating TrustSwaptions to receiving entities, allowing the receiving entities to redeem the TrustSwaptions, and measuring the campaign progress and evaluating ROI from the campaign. The TrustSwaptions are negotiable instruments which grant ownership of the instruments without the obligation to enter into an underlying trade and allow the entities to transact among each other. The ET platform can capture specific transaction patterns exhibited by entities to establish and build Social Bonafide score trustworthiness/morality quotient of the entities. Further, a system for transactions that use the trust-based negotiable instruments between entities or group of entities is also disclosed.

### TECHNICAL FIELD

The embodiments herein generally relates to business transactions between entities, more specifically commercial and non-commercial transactions between entities such as retail consumers, businesses and government departments using a novel instrument that enables building and tracking of trust worthiness quotient of participating entities.

### BACKGROUND

Online transactions generally refer to transactions taking place over internet involving various technologies such as World Wide Web, server, database and data exchange protocols. Commercial transactions take place between two entities (businesses, governments and consumers) for buying and selling, bidding, auction, paying bills, booking tickets etc. while non-commercial transactions take place between government departments and beneficiaries of government schemes, non-governmental organizations (NGOs), and philanthropists.

In merchant-consumer transactions, to provide, more benefits and motivate the entities doing online transactions and also to enhance buyer and seller relationship, several incentive programs are available like discount coupons, brand-associated loyalty card schemes, attractive offers, providing incentives based on analysis of behavioral pattern in the transactions done by customers, purchasing pattern of customers are analyzed to spot potential customers and target them with special offers. There are several other business methods present in the prior art to provide incentives to the buyer or seller based on certain parameters and methods of scoring and ranking the buyer or seller to provide them incentives. However, these are very generic and not personalized for the consumer. As a consequence, meaningful and precise analytics is also not feasible.

In a prior art, to build confidence in transactions between buyers and sellers and gain confidence among plurality of buyers, a method exists to rank and score the seller in a specific range and also makes the score data available to the buyers for transparency. The scoring may be performed based on data collected from a variety of sources, survey ratings, review feedback on free and paid blogs, including combinations of the merchant, third-parties, and/or customers who have transacted with the merchant. However, all of these mechanisms are fairly subjective to an individual's perception of the value derived through the transaction.

It has been observed that the above methods have certain drawbacks. The value of the coupon is decided by the merchant or the vendor. Today's coupon mechanism is mass-based and they rely on redemptions to be applicable based on available stocks. There is also no mechanism for transactions involving exchange, gifting, loaning, and repayment of coupons. The intent to transact, the confirmation of the intent and the transaction that follows such intent is not captured to build analytics on buyer and seller behaviour. The filtering of offers is decided by merchants or their representatives or control mechanisms available.

There therefore exists a need in the art to provide methods and systems which can encourage in doing on-line transactions between entities those trust each other. Further, such methods and systems should be able to do dynamic scoring of the entities based on the transaction patterns between the entities. Additionally, the methods and systems should able to provide a negotiable instrument that can grant the ownership without the obligation to enter into an underlying trade. The methods and systems should enable the entities to transact among each other using the instrument, and also capture specific business transactions capturing specific business patterns exhibited during transactions using the instrument.

Further, the systems and methods should provide the instrument to consumers based on dynamic trust score of the consumers. Such kind of transaction platform is needed for a dynamic e-marketplace where each entity can get trust based incentives for their initiatives taken to provide offers and benefits to other entity and for the healthy transactions taking place among themselves and also to help to build a long term business relationship between them.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In view of the foregoing, some embodiments herein disclose methods and systems [hereinafter referred to as Earn Trust (ET) platform] for transactions that use a trust-based instrument [herein referred as TrustSwaption] between entities or group of entities.

According to an embodiment, a method for trust based transactions between entities or group of entities, the method comprising the step of inviting one or more entities to register on ET platform, allowing one or more issuing entities to set at least a campaign and/or contract, distributing and activating TrustSwaptions to receiving entities, allowing the receiving entities to redeem the TrustSwaptions, and measuring the campaign progress and evaluating return on investment [ROI] from the campaign, wherein the TrustSwaptions are negotiable instruments which grant ownership of the instruments without the obligation to enter into an underlying trade and allow the entities to transact among each other, wherein the ET platform captures specific transactions patterns exhibited by entities during transactions using the TrustSwaptions, to establish and build trustworthiness/morality quotient of the entities. In a further embodiment, allowing the receiving entities to gift the TrustSwaptions to another receiving entity and/or for social causes, and lend the TrustSwaptions to another receiving entity.

According to an embodiment, the distribution/issuance of TrustSwaptions to the entities may vary based on the entities' trustworthiness score (herein referred as “Social Bonafide Score” or SB score). As entities engage in transactions, the ET platform can analyze different aspects of the transaction and update the SB score for the transacting entities.

According to an embodiment, a system for trust based transactions between entities comprising at least a user interface device, and an application server including an ET engine, wherein the ET engine can include a receiving module, a registration module, a notification module, a TrustSwaptions exchange and management module, an OTP transaction module, a 3-way match module, a reminder module, an SB score calculator module, an exchange rate identifier module, a campaign/scheme management module, a bid management module, a reporting module, a search module and a link module.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a block diagram showing a sample network environment within which systems and methods for business transactions using trust based incentives is implemented, in accordance with an embodiment herein;

FIG. 2 illustrates a block diagram showing an ET engine, in accordance with an embodiment herein;

FIG. 3 illustrates a flow chart showing merchant registration and campaign creation flow, in accordance with an embodiment herein;

FIG. 4 illustrates a flow chart showing TrustSwaptions redemption flow, in accordance with an embodiment herein;

FIG. 5 illustrates a flow chart showing TrustSwaptions borrow flow, in accordance with an embodiment herein;

FIG. 6 illustrates a flow chart showing TrustSwaptions gift/share flow, in accordance with an embodiment herein;

FIG. 7 illustrates a flow chart showing bidding flow, in accordance with an embodiment herein;

FIG. 8 illustrates a flow chart showing campaign management flow, in accordance with an embodiment herein;

FIG. 9 illustrates a flow chart showing types of Social Bonafide score (SB score), in accordance with an embodiment herein;

FIG. 10 illustrates a flowchart showing government department registration and linking with public welfare schemes, in accordance with an embodiment herein; and

FIG. 11 illustrates a flowchart showing debt setting with another government department method, in accordance with an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

It is to be noted that even though the description of the invention has been explained using entities such as merchants, consumers, government, business entities and organization, it should, in no manner, be construed to limit the scope of the invention. The systems and methods of the invention are not limited to any specific geography, industry vertical, or domain.

Merchants or businesses or commercial establishments are herein referred to as merchants, and prospects or beneficiaries or end-consumers, are referred to as consumers throughout the description. Further, the term entities are collective term herein refers to governments, merchants, consumers, NGOs, and philanthropists. As used herein, the term “and/or,” when used in a list of two or more items, means that any one of the listed items can be employed by itself, or any combination of two or more of the listed items can be employed.

In some embodiments, methods and systems [hereinafter referred to as Earn Trust (ET) platform] for transactions that use a trust-based instrument between entities or group of entities. The transactions could be merchants-to-merchants, merchants-to-consumers, consumers-to-consumers, consumers-to-NGOs/civic bodies, government-to-consumers, government-to-merchants, and government-to-government resulting in all-round benefits for all participating entities and to the society at large.

According to an embodiment, negotiable instruments [herein referred as TrustSwaptions] are provided to the entities which grant ownership of the instruments without the obligation to enter into an underlying trade, wherein the entities can transact among each other using the TrustSwaptions. The ET platform can also capture specific business patterns exhibited by entities during transactions using the instruments to establish and build trustworthiness/morality quotient of the entities.

In an embodiment, the TrustSwaptions may be provided in three types namely m-TrustSwaptions, g-TrustSwaptions, and ET-TrustSwaptions, wherein m-TrustSwaptions are distributed by merchants to their current and potential consumers, g-TrustSwaptions are distributed by the government to beneficiaries/consumers/merchants who meet the criteria to pass benefits such as subsidies, federal benefits, and contract completion amounts. ET-TrustSwaptions are credited by ET platform to the accounts of all participating entities based on transactions involving the exercise of TrustSwaptions.

According to an embodiment, a method for trust based transactions between entities or group of entities, the method comprising the step of inviting one or more entities to register on ET platform, allowing one or more issuing entities to set at least a campaign and/or contract, distributing and activating TrustSwaptions to receiving entities, allowing the receiving entities to redeem the TrustSwaptions, and measuring the campaign progress and evaluating return on investment [ROI] from the campaign, wherein the TrustSwaptions are negotiable instruments which grant ownership of the instruments without the obligation to enter into an underlying trade and allow the entities to transact among each other, wherein the ET platform captures specific transactions patterns exhibited by entities during transactions using the TrustSwaptions to establish and build trustworthiness/morality quotient of the entities. In a further embodiment, allowing the receiving entities to gift the TrustSwaptions to another receiving entity and/or for social causes, and lend the TrustSwaptions to another receiving entity. In a further embodiment, distribution of TrustSwaptions may include converting loyalty schemes or vouchers issued by entities to their customers registered on ET platform.

According to an embodiment, issuing entities are merchants and government departments, and receiving entities are consumers and contractors.

According to an embodiment, the method for trust based transactions between consumers and merchants may comprise the step of inviting merchants to register on ET platform, inviting consumers to register on ET platform, allowing merchants to set campaigns, distributing and activating of m-TrustSwaptions to the consumers, allowing the entities to redeem the m-TrustSwaptions, and measuring the campaign progress and evaluating ROI from the campaign. The methods further comprises of allowing the consumer to gift the m-TrustSwaptions to another consumer and/or for social causes, and lend the m-TrustSwaptions to another consumer. In a further embodiment, distribution of TrustSwaptions may include converting loyalty schemes or vouchers issued by entities to their customers registered on ET platform.

According to another embodiment, the method for trust based transactions between consumers and governments may comprise the step of inviting government departments to register on ET platform, inviting consumers to register on ET platform, allowing government department to set campaigns, distributing and activating of g-TrustSwaptions to the consumers, allowing the entities to redeem the g-TrustSwaptions against government dues and/or with other merchants/consumers in return for products/services or at authorized banks in return for cash to be transferred to the beneficiaries' account, and measuring the campaign progress and evaluating ROI from the campaign.

According to another embodiment, the method for trust based transactions between governments and enterprises may comprise the step of inviting government departments to register on ET platform, inviting enterprises [herein also referred as contractors] to register on ET platform, allowing government departments to set contracts, bidding and tendering the contracts, distributing and activating of g-TrustSwaptions to the contractors, allowing the contractors to redeem the g-TrustSwaptions, and providing analysis flow of g-TrustSwaptions in the ET platform among contractors and the overall response.

According to an embodiment, merchants and government departments can be invited to register on the ET platform, and consumers may enroll on the platform through invitations initiated by any of the entities. Accordingly, consumers can trade m-TrustSwaptions for the purchase of exclusive products and/or services from the merchant. Consumers can use g-TrustSwaptions towards payment of government dues and/or receive cash as beneficiaries for government schemes. Further, the consumers can exercise the value of the g-TrustSwaptions for specific product and/or service purchases from the government and/or to receive cash by trading g-TrustSwaptions at banks.

According to an embodiment, the issuance of ET-TrustSwaptions to the entities may vary based on the entities' trustworthiness score (herein referred as “Social Bonafide Score” or SB score). As entities engage in transactions, the ET platform can analyze different aspects of the transaction and update the SB Score for the transacting entities.

In an embodiment, the SB score of entities may be derived based on the activities in the ET platform, wherein the activities may include but not limited to issuance of TrustSwaptions to consumers, redemption of TrustSwaptions by consumers, commitment of both parties to the timelines for the transaction, commitment of a seller to the quality/service levels, lending TrustSwaptions to another consumer, repayment of loaned TrustSwaptions to the lender, and gifting the TrustSwaptions for social causes and/or to another consumer. The increase/decrease in the SB score may have a direct bearing on the value of the ET-TrustSwaptions that the entity accumulates on the ET platform in a manner that becomes beneficial for consumers, merchants, and the community at large, delivering an ultimate WIN-WIN situation for commercial and non-commercial participants. In an embodiment, transacting entities can view the SB score for the other parties as the basis for decisions on initiating/requesting further transactions with the entities.

In an embodiment, exchange rate is a multiplication factor, wherein the exchange for the entity's ET-TrustSwaptions is derived based on SB score. In an embodiment, the base exchange rate for every entity is 1. When the entities' SB scores are updated based on the transactions that they carry out on the platform, the exchange rate would vary between a lower threshold of 1 and higher values than the lower threshold.

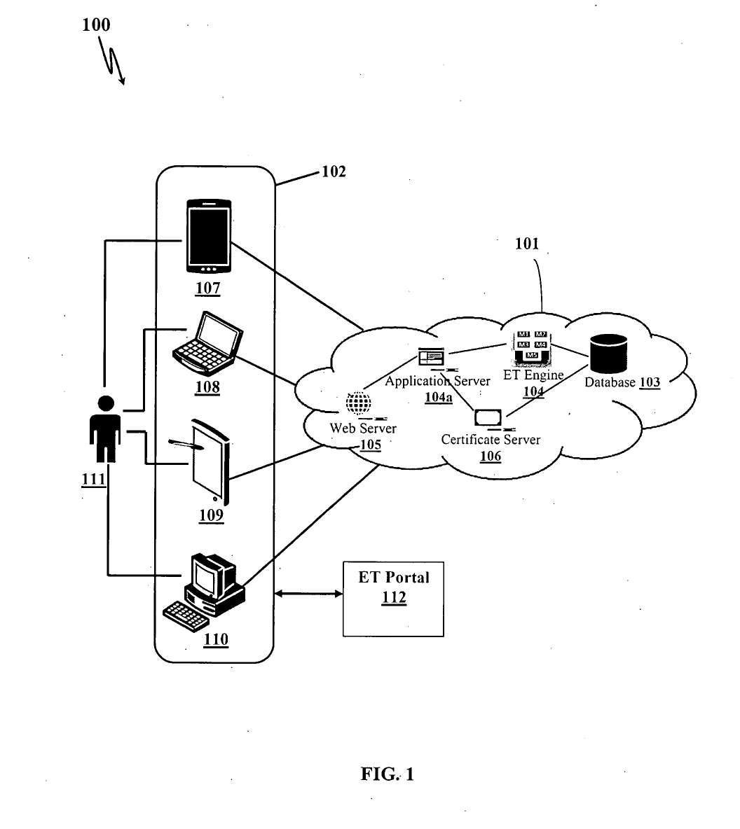

FIG. 1 is a block diagram showing a sample network environment 100 within which systems and methods for business transactions using trust based instrument can be implemented, in accordance with an example embodiment. As shown in FIG. 1, the network environment may comprise a network 101, user interface devices 102, a database 103, an application server 104a including an ET engine 104, a web server 105, and a certification server 106. The network 101 may include a plurality of data processing nodes interconnected for the purpose of data communication. The network 101 may be hosted in the cloud or it may also be hosted privately by enterprises or other entities. Other components of the network environment 100 can utilize the network 101 to receive, transmit, and store data as well as for the purpose of accessing remote resources.

The user interface devices 102 may include but not be limited to a smart phone 107, laptop 108, tablet 109 or a PC 110 to facilitate transmitting and receiving data over the network 101, wherein an ET portal 112 or application [referred herein ‘Apps’] running on user interface devices 102 can permit entities 111 to interact with the ET engine 104.

The database 103 may be utilized to store data processed by the ET engine 104. In some example embodiments, the data stored in the database 103 can originate in transactions external to the ET engine 104. The database 103 can also store data related to various entities 111 who are participating in the transactions.

The ET engine 104 can be utilized to process trust based transactions including but not limited to the selling and/or buying goods or services, advertising goods or services, offering goods or services, offering incentive for purchasing or selling goods or services, and contributing to social causes. The ET engine 104 can use the network environment 100 at least at some point in the transaction's patterns although it may comprise a wider range of technologies.

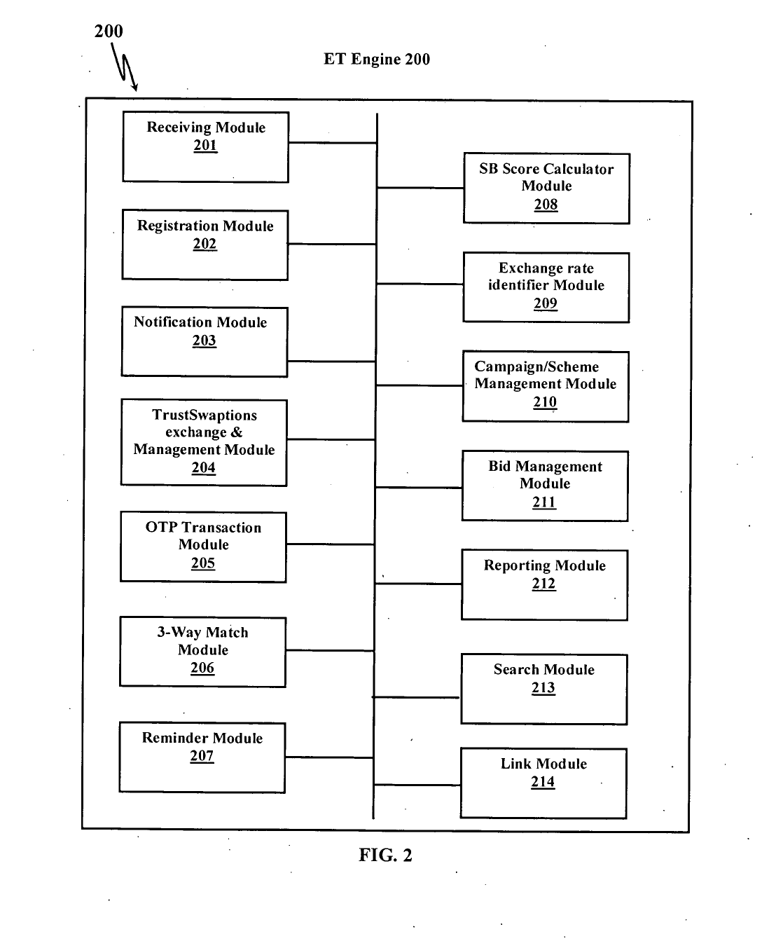

FIG. 2 illustrates a block diagram showing the ET engine 200, in accordance with an embodiment. The ET engine 200 can include several components that may be configured to perform various operations. As shown in FIG. 2, the ET engine 200 can comprise a receiving module 201, a registration module 202, a notification module 203, a TrustSwaptions exchange and management module 204, an OTP transaction module 205, a 3-way match module 206, a reminder module 207, an SB score calculator module 208, an exchange rate identifier module 209, a campaign/scheme management module 210, a bid management module 211, a reporting module 212, a search module 213 and a link module 214.

In one embodiment, the processing logic resides at the ET engine 200 and each of these modules may comprise processing logic. The method may be performed with various modules as discussed in FIG. 2.

The components of the ET engine 200 can facilitate online trade transactions, for example, trade, campaign creation, buy, sell, gift, borrow, redemption, and bid. In a typical online trade process, the receiving module 201 may be configured to receive the data related to each entity and also data related to transactions which takes place between them.

According to an embodiment, the registration module 202 can be configured to invite the merchants and government departments to register on the ET platform; and allow the consumers to register on the ET platform through invitations initiated by the merchants or government departments.

According to an embodiment, the notification module 203 can send notification to consumers about new campaigns created by merchants and the received m-TrustSwaptions, send notification to consumers about new Programmes created by government departments and the received g-TrustSwaptions, and also to send notifications to contractors about g-TrustSwaptions that get vested. The notification module 203 can also notify the consumers about potential expiry of unused m-TrustSwaptions in their account, notify consumers of the outstanding TrustSwaptions to be repaid towards borrowings and notify the consumers about their probability of striking a good exchange rate for trading of ET-TrustSwaptions with m-TrustSwaptions from open pool. Further, the notification module 203 can notify either the campaign or programme initiator about the flow of the TrustSwaptions through the system, highlighting interest among existing consumers and bids from the open pool indicating anonymous prospects, notifications on conversion of an anonymous prospect to a registered consumer through the exchange of ET-TrustSwaptions for m-TrustSwaptions. Also, when the consumers and the merchant agree upon the exchange of TrustSwaptions, the notification module can retrieve a one-time transaction key [OTP code] issued by the OTP transaction module 205 and can send it to the consumer. Another notification can be sent to the merchant to inform about the verification status of the OTP code which the consumer uses to exercise the m-TrustSwaptions. Notifications can also be sent to merchants based on information received from the search module 213 as explained below in search module 213 functions.

According to an embodiment, the TrustSwaptions exchange and management module 204 can create and distribute TrustSwaptions to the entities, allowing the entities to exercise, gift, lend the issued TrustSwaptions, and also making the expired TrustSwaptions available in an OPEN POOL for bidding by entities.

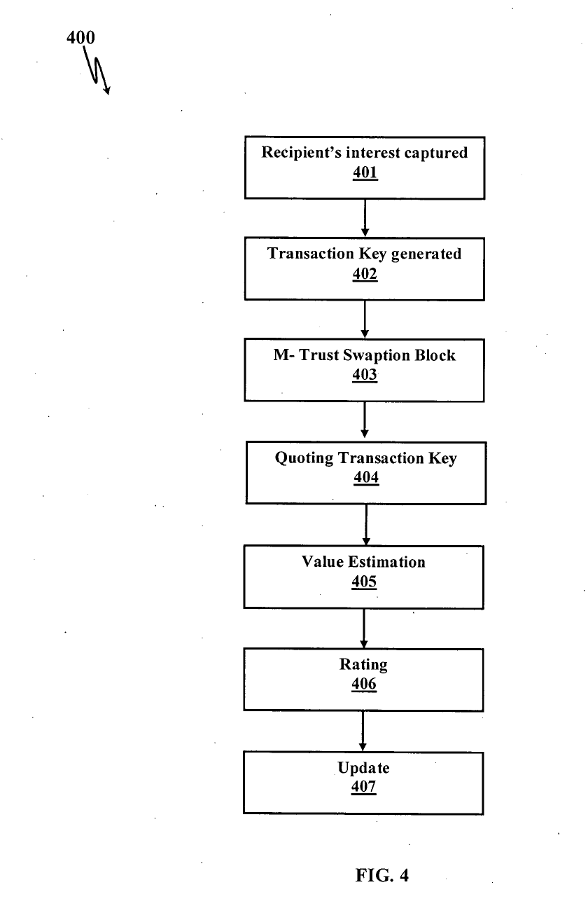

In accordance with an embodiment, the OTP transaction module 205 can create a unique OTP code for sending to both sender and receiver, when the recipient of the TrustSwaptions wishes to redeem the TrustSwaptions for purchase of some product/service/offer. Upon purchase, the receiver can quote the unique OTP code and the merchant can enters the unique OTP Code into the ET portal 112 or Apps so that the system can identify the applicable exchange rate of the ET-TrustSwaptions as explained below referring FIG. 4.

According to an embodiment, the 3-way match module 206 can gain relevance when the entity intends to redeem the m-TrustSwaptions and goes through the notification process as explained in above notification module 203 and the OTP transaction module 205 explained above to ensure that both parties have met their obligations towards each other. After the successful 3-way match of a transaction involving m-TrustSwaptions, ET-TrustSwaptions are issued to both the entities as a reward for meeting their obligations.

According to an embodiment, the reminder module 207 can serve the purpose of reminding entities of the upcoming expiry of their campaigns and programmes or upcoming expiry of TrustSwaptions.

In accordance with to an embodiment, the SB score calculator module 208 can calculate the SB score of entities based on activities/transactions of the entities, wherein the activities may include but not limited to issuance of TrustSwaptions to consumers, redemption of TrustSwaptions by consumers, lending TrustSwaptions to another consumer, repayment of loaned TrustSwaptions to the lender, gifting the TrustSwaptions for social causes and/or to another consumer, and timely completion of committed transactions by entities.

According to an embodiment, the SB score calculator module 208 can assign the SB score to entities based on their credibility and social rating that is already established. The ET platform can also provide multiple means of measuring the entities' credibility and ratings.

In accordance with an embodiment, the exchange rate identifier module 209 can be configured to identify the exchange rate of entities based on their SB score. New entities in the system start with an SB score of one. As the entities participate on the system through TrustSwaptions, the system analyses their behaviour as a function of the behaviours of other entities in their respective circles of influence (orbits) and resulting in positive or negative swings in their SB scores and exchange rates. This exchange rate can be used at the time of completion of a transaction as a multiplier of the ET-TrustSwaptions that can be redeemed.

In accordance with an embodiment, the campaign management module 210 can enable merchants to create a campaign with product/service collateral, define the total value of the campaign, define the total number of consumers to target with m-TrustSwaptions (for the campaign), upload/enter the contact details of consumers to whom the m-TrustSwaptions are to be distributed. Further, the merchants can add consumers into various categories. (Platinum, Gold, Silver, and Bronze) which entitle a differentiated distribution of the m-TrustSwaptions. In another embodiment, the scheme management module 211 can enable government departments to create programmes/schemes and define the total number of beneficiaries (consumers) to target with g-TrustSwaptions (for each programme/scheme), and upload/enter the contact details of consumers to whom the g-TrustSwaptions are to be distributed.

According to an embodiment, the system can maintain an OPEN POOL to store the expired m-TrustSwaptions which are moved out of consumers' accounts. All registered entities of the ET platform can view the offers in the OPEN POOL.

According to an embodiment, the bid management module 211 can enable all registered entities of the ET platform to ‘bid’ for specific offers in the OPEN POOL, wherein the offers includes unused or expired m-TrustSwaptions.

According to an embodiment, the report module 212 can be configured to generate report about the data at the end of the campaign for ROI, and data related to repeat purchases, SB score gains for the gainers, new entities acquired and interest in the open pool for offer. In case of redemption of g-TrustSwaptions, a report may be generated stating redeemed amount as cash status, redeemed as TrustSwaptions status, traded for other debt, total spend used. The report module can also provide trending reports on exchange rates, and SB scores.

According to an embodiment, the search module 213 can enable entities to search for products or services on the ET platform and identify other connected entities who may have unused m-TrustSwaptions relevant for the purpose. The search module 213 can also enable entities to search through the OPEN POOL for offers from relevant merchants that entail trading in ET-TrustSwaptions for m-TrustSwaptions. Additionally, entities can perform general search operations (which are not tied to any offers) in the OPEN POOL for products or services. When such a search operation occurs in the OPEN POOL, the search module can pass on the to the notification module 203, the information retrieved and anonymous references to the entity who performed the search operation along with the related SB score.

In an embodiment, the link module 214 can enable entities to establish and manage connections, associate certain number of TrustSwaptions with each connected entity, associate search for specific offers with specific entities, associate SB scores with the entities, associate the TrustSwaptions with the current owners and previous owners and maintain the chain or history of TrustSwaptions movements between entities.

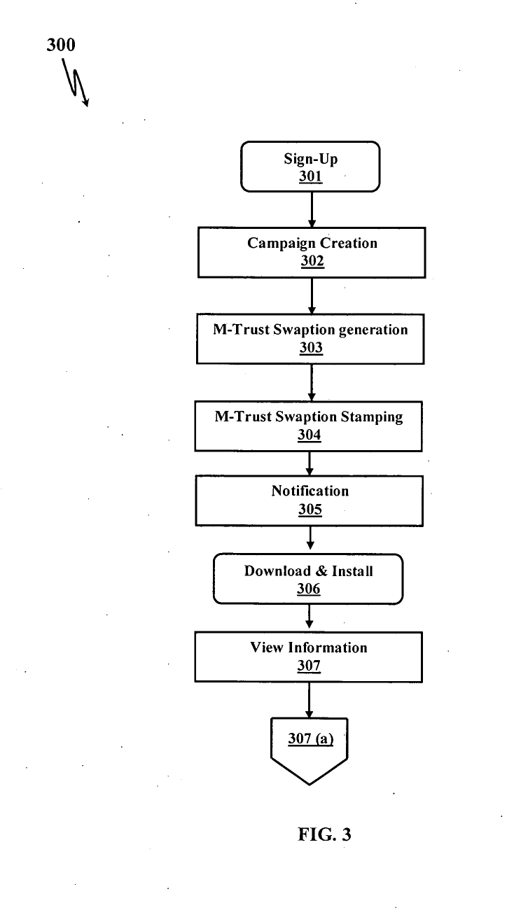

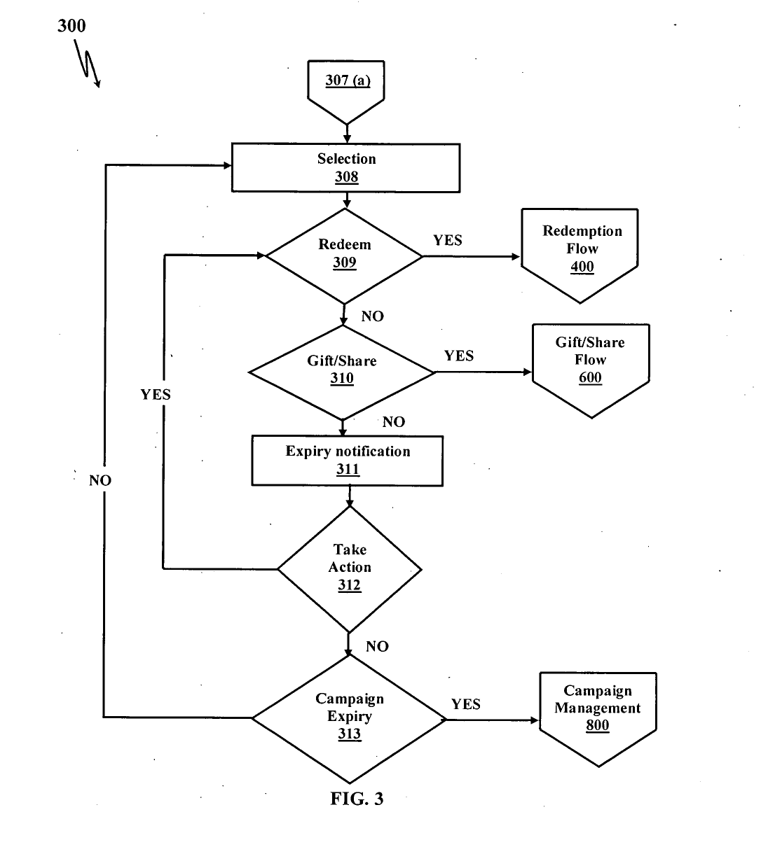

Exemplary methods for implementing a system for business transactions using trust based transactions are described with reference to FIGS. 3-13. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer executable instructions may be located both in local and remote computer storage media, including memory storage devices.

The exemplary methods are illustrated as a collection of operations in a logical flow graph representing a sequence of operations that can be implemented in hardware, software, firmware, or a combination thereof. The, order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 3 illustrates a flowchart showing a method 300 for merchant registration and campaign creation flow, in accordance with an embodiment. The method 300 may commence at operation 301, wherein the merchants 111 can sign-up in the ET platform and become registered entities. At operation 302, the registered merchants 111 can create campaign in the system with product/service collateral, define the total value of the campaign, identify the consumer [may also referred herein as beneficiary] to whom the invitation to join the campaign and also decide whether outstanding campaign amount should go into the open pool or not. Further, the merchants 111 can upload/enter the contact details of consumers, and can add consumers into various categories (Platinum, Gold, Silver, and Bronze) which entitle a differentiated distribution of the m-TrustSwaptions to whom the m-TrustSwaptions are to be distributed. In another embodiment, the merchants can distribute m-TrustSwaptions to entities that have a specific SB Score irrespective of access to contact information, The PII of entities, who are not yet consumer of the merchant, are not shared until the entities choose to redeem the m-TrustSwaptions. At operation 303, the system may generate m-TrustSwaptions based on the value of the campaign and distribute it to the consumer. At operation 304, the generated m-TrustSwaptions may be stamped with receiver and sender. At operation 305, the system may send notification to the receiver of the m-TrustSwaption that they have received such benefits from the sender. At operation 306, the entity 111 who is accessing the system for the first time may have to download the system application into the device and install it by agreeing privacy statement, and entity 111 can access the invitations on their devices and register on the platform (if not already registered), wherein the registered entity can access their m-TrustSwaptions using the device and their registered accounts. At operation 307, the entity can view information which may include offers available through merchants as part of a targeted campaign, offers in the open pool, SB score and the corresponding exchange rate is applicable to them as part of their SB score, percentile ranking on their trust list and across the entire community, and view their Trust trend graph and entity category based on their trust score (e.g. silver, gold, platinum, fellow etc), search for offers in their contact list without sharing PII of the requestor and the entity who holds the m-TrustSwaptions, anonymously request for borrowing the m-TrustSwaptions without sharing the PII of either party. At operation 308, the receiver can select one option among plurality of options. At operation 309, the beneficiary can go for redemption of m-TrustSwaption for purchase of certain product and/or service, or at operation 310, the receiver can choose to gift/share m-TrustSwaption with their ET contacts. At operation 311, the beneficiary may again notified about the m-TrustSwaption till its expiry date is reached, within which the receiver can transact, if they have not taken any action till this point. At operation 312 the receiver may have an opportunity to take action and go back to operation 309 for redemption or gift or share of m-TrustSwaptions. At operation 313 if no action is taken and campaign expiry date is reached then it can be taken care by campaign management method.

FIG. 4 illustrates a flowchart showing a method 400 of TrustSwaption redemption in accordance with an embodiment, wherein the m-TrustSwaption received can be redeemed for purchase of product or service. In an embodiment, the consumer can choose a particular offer and use the gesture “Redeem”, and can choose to trade their accumulated ET-TrustSwaptions as a percentage of the m-TrustSwaptions, and accordingly the available ET-TrustSwaptions in the recipient's account may be the ET-TrustSwaptions vested multiplied by exchange rate.

ET-TrustSwaptions in entity's account=ET-TrustSwaptions credited by the ET Platform×exchange rate Equation (1)

wherein the exchange rate is derived from the entity's SB score. The higher the exchange rate, the better is the value of the ET-TrustSwaptions held by each entity thereby giving them greater benefits.

Further, the system may check if an early bird offer is applicable and accordingly can generate/send the consumer a unique code that can be used at the merchants for redemption. At the time of redemption, the merchants can validate the unique redemption code on the ET platform to ensure its validity. During redemption, the total credit availed by the consumer may be the m-TrustSwaptions+ET-TrustSwaptions that they have opted to trade. Moreover, the ET-TrustSwaptions may be debited from their account and credited into the merchant's account. In an embodiment, the merchants may have the registered entities contacts and can mark them for future targeting (if applicable). Additionally, the merchant can also use their accumulated ET-TrustSwaptions to secure a waiver in subsequent campaigns. In return for the transactions, the platform may reward the consumer, their ‘repeat purchase’ with ET-TrustSwaptions. If the consumer is a potential consumer (through a gift/lend), then the donor may be credited with ET-TrustSwaptions appropriately. Based on the value of the transaction, a fixed percentage of the redemption may be routed for social causes on behalf of the merchant and consumer.

Now referring to FIG. 4, at operation 401, wherein the recipient's interest for redemption of TrustSwaptions with the proposed timeline of purchase can be captured and routed to the merchant. At operation 402, the system may generate a unique one-time transaction key and send to both merchant and consumer for the transaction. At operation 403, the system may also block the m-TrustSwaptions of the consumer and early bird offers of the merchant (if applicable) for transaction. At operation 404, upon purchase, the consumer can quote the unique one-time transaction key. At operation 405, the merchant may also require to enter the unique number into the ET portal 112 or Apps, and the system may identify the applicable value of m-TrustSwaptions exchange. At operation 406, the consumer may be asked to survey/rate the merchant based on their buying experience and also the quality of product/service purchased once the transaction is complete. At operation 407, the system may calculate and update the SB score of the transacting parties based on a variety of factors including but not limited to whether the transaction was completed within the proposed time quoted by the consumer and may credit the transacting parties' account ET-TrustSwaptions based on the percentage of m-TrustSwaptions exchanged. Further, the merchant's SB score may also be updated based on the quality of the transaction and the survey response provided by the entity.

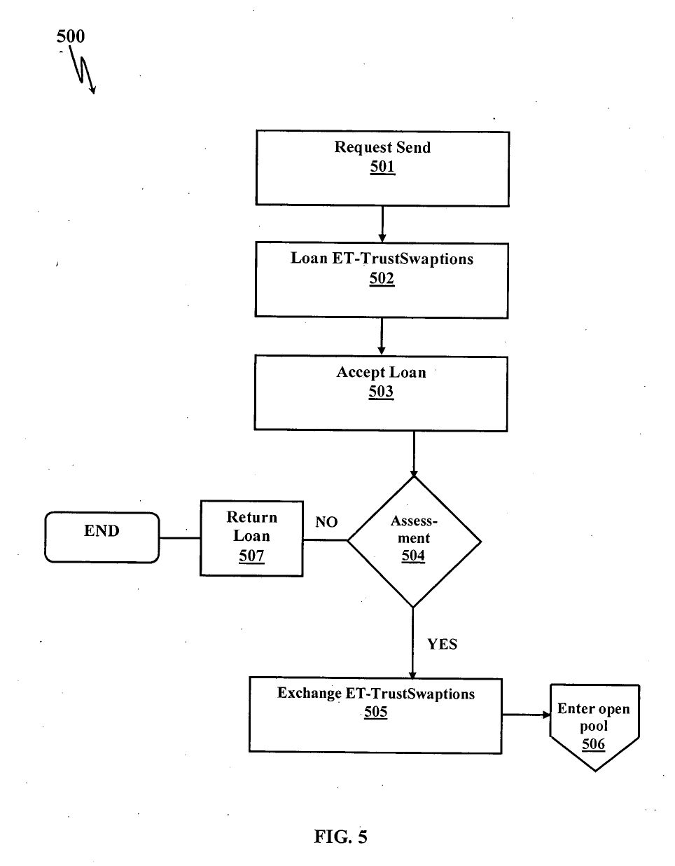

FIG. 5 illustrates a flowchart showing a method 500 of TrustSwaptions borrowing process, in accordance with an example embodiment, wherein a potential entity who has not received the exclusive offer or m-TrustSwaptions from the merchant and is interested in the specific offer from the Open Pool. At operation 501 the ET platform allows the entity to borrow from their contacts the required number of ET-TrustSwaptions needed to bid for the offer in the Open Pool. Such potential entities can send a request to their ET contacts in the system stating the former's interest to bid for an item and requesting for a loan of their ET-TrustSwaptions. At operation 502, the ET contacts can respond by lending their ET-TrustSwaptions. At this point the ET platform can start tracking important parameters such as the duration that the borrower utilizes before repaying the borrowed ET-TrustSwaptions. The ET platform can update the SB Score of the borrower based on the tracking of repayments and notify the lender about the intermittent variations in the SB Score of the borrower between successive loan requests. The ET platform can also benchmark the borrower's SB score variations based on the tracking with the variations averaged across the entire ET platform. Should the lender require the loaned ET-TrustSwaptions for redemption against another offer, the ET platform can credit the lender's account with a fresh lot of ET-TrustSwaptions equivalent to the number of loaned ET-Swaptions. The ET-platform can tally the ET-TrustSwaptions by following up with borrowers and tracking the repayment of borrowed ET-TrustSwaptions. The ET platform can also update the SB score of the borrower based on factors such as duration taken to return the borrowed ET-TrustSwaptions. At operation 503, the interested entity can choose to accept ET-TrustSwaptions from multiple lenders subject to limits applicable for the SB score of the borrower. If the borrower exceeds the fair usage policy, the ET platform would quarantine the borrower preventing further transactions on the ET platform. Quarantined entities however can view offers and transactions occurring on the ET platform. Further, the system may increment the SB score of the lenders for their gesture. At operation 504, the system may assess whether the interested entity have got enough ET-TrustSwaptions to bid for the offer. At operation 505, the potential entities receive the ET-TrustSwaptions from the lender. At operation 506, the potential entities places bid for the exclusive offer available in the open pool. At operation 507, the interested candidates who do not possess enough ET-TrustSwaptions to bid may have to return back the loaned ET-TrustSwaptions to the lender.

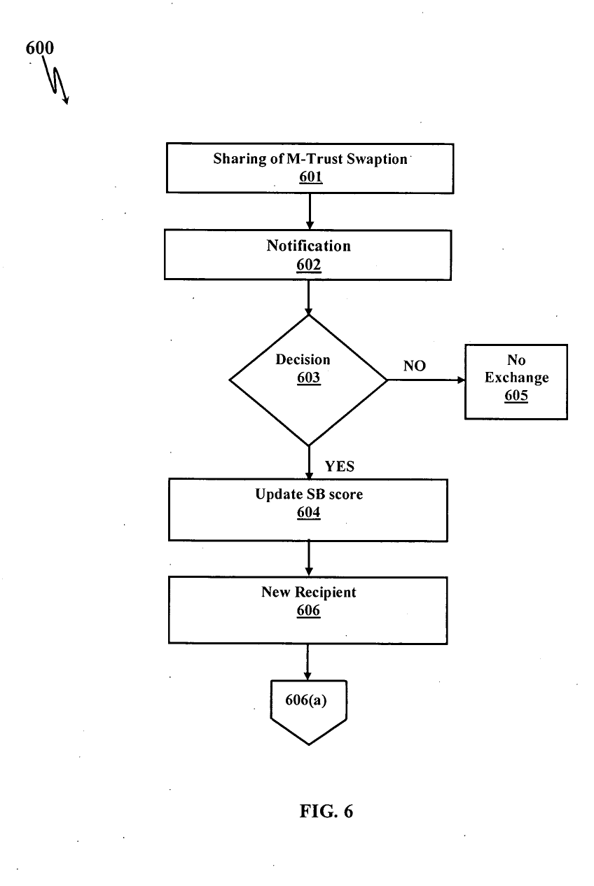

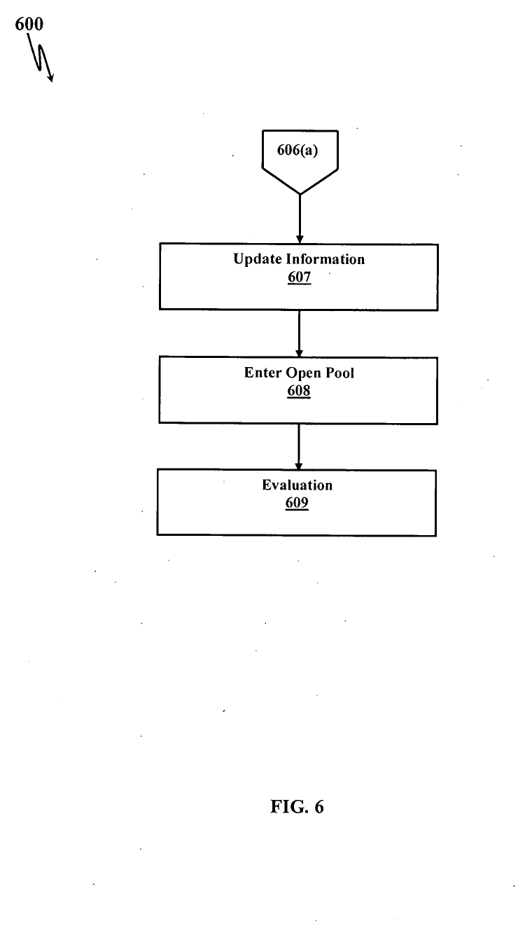

FIG. 6 illustrates a flow chart showing a method 600 of TrustSwaptions gift/share process, in accordance with an embodiment, wherein the system may provide an option to all the entities to gift or share their m-TrustSwaptions, which in turn may affect the SB score of the entities. At operation 601, the original offer recipient may share the offer with their registered ET contacts of the system or to an unregistered individual who might be interested to redeem the offer. At operation 602, the recipients may receive the notification from their contact and can choose to accept the gift or not. At operation 603, if receivers choose to accept the gift, then at operation 604, the donor's SB score may be updated for the gesture of sharing and at operation 605, if the receiver does not accept the gift, then the m-TrustSwaptions may remain with the original recipient. At operation 606, the new recipient would only have the capability to exercise the m-TrustSwaptions before they expiry date. At operation 607, the system may update the details which may include m-TrustSwaptions' new recipient details, ‘shared’ and ‘received’ gift value of each entity in the transaction, and ET-TrustSwaptions are credited into the donor's account. At operation 608, if the m-TrustSwaptions are not exercised within the expiry date then it may enter into the open pool. However, the recipient's account may show a negative balance for having chosen to accept the gift. At operation 609, the system may periodically evaluate the ‘shared’/‘received’ score of each individual involved in sharing and encourages them to share m-TrustSwaptions to improve their SB scores which ultimately benefits them to do more transactions.

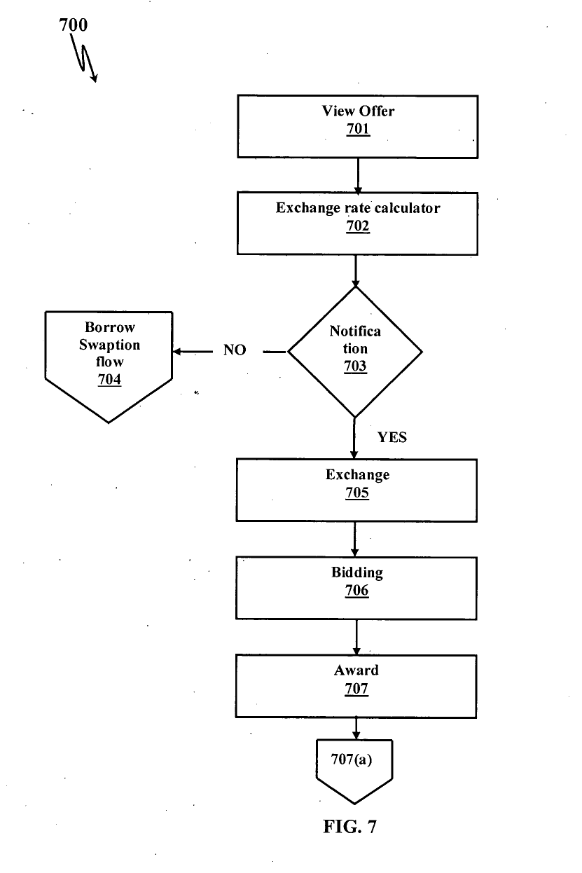

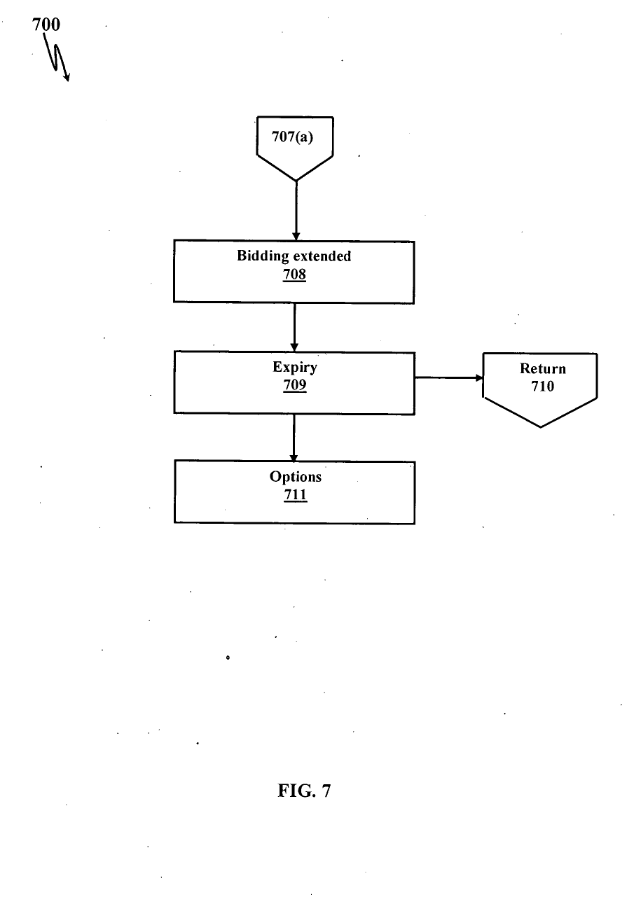

FIG. 7 illustrates a flowchart showing a method 700 of the open pool process that takes place in open pool when the unused and expired m-TrustSwaption enters into the open pool, according to an embodiment. Accordingly, upon the campaign reaches the expiry date and transaction is no longer possible, then the unused m-TrustSwaptions may enter into the open pool wherein all the registered ET entities can bid for the offer, wherein the offer includes unused or expired m-TrustSwaptions. At operation 701, all the registered entities of system may be able to view the offer in the open pool. At operation 702, the system may calculate the exchange rate for the entity's ET-TrustSwaptions based on SB score. At operation 703, the system may check if the interested entities have sufficient ET-TrustSwaptions or not. At operation 600, the system may provide an option to the consumers who do not have enough ET-TrustSwaptions to borrow ET-TrustSwaptions from their ET contacts to be able to bid, and to increase the chance to get the m-TrustSwaptions. The consumer can also choose to increase their bid through additional loans of ET-TrustSwaptions from their contacts. At operation 705, the transaction process may continue for the qualified consumers who are interested to bid for the offer, and accordingly the consumer can place their bid by opting to trade ET-TrustSwaptions in return for m-TrustSwaptions. At operation 706, number of the interested consumers indicated by the number of bids may become visible to the merchant along with the bidding consumers' SB score and the bidding consumers' ranking among all consumers in the system which is represented as a percentile score. However the consumer's Personally Identifiable Information (PII) may not be shared with the merchant at this point of time. At operation 707, the system may provide option to the merchant that they can award the bid to the interested consumer or extend the bidding process to improve the quality and number of bids. At operation 708, if the bidding process is extended then the merchants can continue to look for favourable bidders. At operation 709, if the open pool campaign expiry date is reached then the merchant may have to award the bid to at least one of the interested bidders, and at this time the PII of the bidder may be disclosed to the merchants. At operation 710, the unsuccessful bidders may return the borrowed ET-TrustSwaptions to the original owner of the ET-TrustSwaptions, At operation 711, if the merchant's account shows a deficit in the number of redeemed m-TrustSwaptions, the merchant may include extend outstanding offers to the additional bidders, enrich the current campaign to accommodate the other bidders, transfer the unredeemed m-TrustSwaptions to another campaign, or donate the unredeemed m-TrustSwaptions for specific social causes (this activity may lead to increase in SB score). If the merchant's account tallies for the number of m-TrustSwaptions issued and redeemed, the surplus ET-Swaptions placed by the bidders will be donated for specific social causes (this activity may lead to increase in SB score of the merchant).

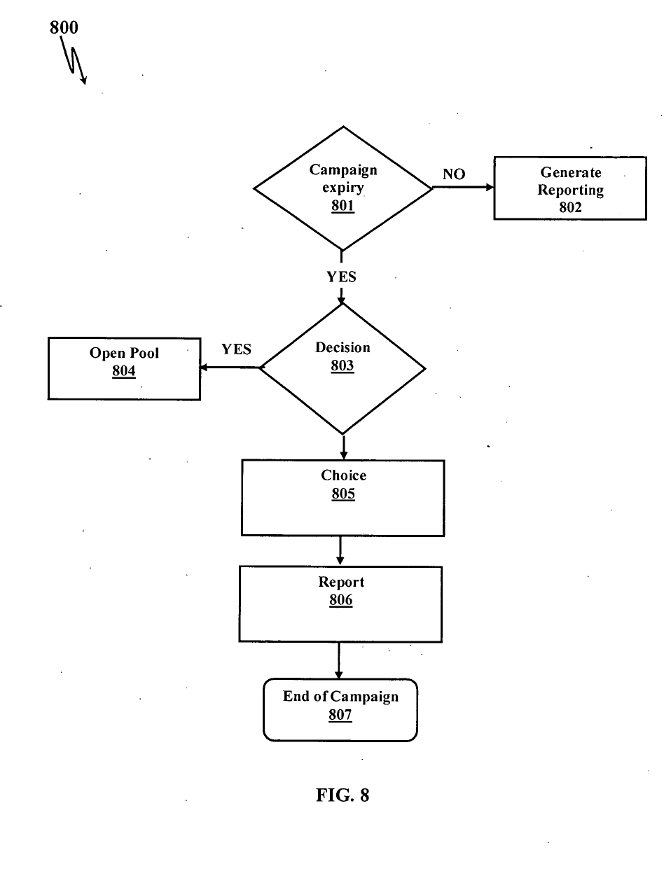

FIG. 8 illustrates a flowchart showing a method 800 of campaign management process and report generated at end of the campaign, in accordance with an embodiment. At operation 801, the system checks if the campaign has expired. If not then, at operation 802, the system may generate report for ROI, repeat purchases, SB score gains for the gains, new entities acquired and if applicable interest in the open pool for offer. Otherwise, at operation 803, the system may check if the campaign marked for open pool or not. In case, the campaign is marked for open pool, then at operation 804, the m-TrustSwaptions may move into the open pool for other registered entities to bid. In case, the campaign is not marked for open pool, then at operation 805, the merchant can choose to do the following:, 1) transfer the m-TrustSwaptions to another campaign 2) donate the unused m-TrustSwaptions for specific social cause (this activity can improve their SB score). Accordingly, at operation 806, the system may generate report for ROI, repeat purchases, SB score gains, and new entities acquired. At operation 807, the campaign ends.

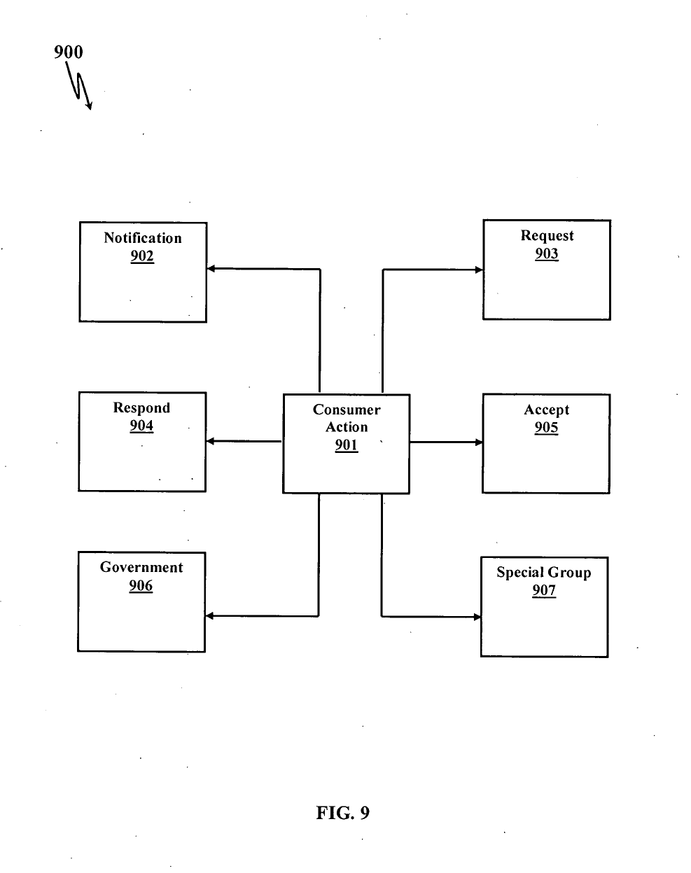

FIG. 9 illustrates a method 900 explaining types of activities which can be done by the entity to improve the SB score, in accordance with an embodiment. At operation 901, where the ET entity can take several actions as following operations 902 to 907. At operation 902, the entities can send notification to other contacts about joining the network, and when these are accepted the entities' SB scores improve. In this way, the ET contact list can be built over time. At operation 903, the entities can request information from their ET contact list for a specific piece of information/advice. At operation 904, the entities can respond to the trust contacts need through recommendations. At operation 905, the entities can accept responses and recommendations and the respondents' SB score is improved. At operation 906, the government can earmark organizations (NGO's, civic bodies involved in society upliftment, higher educational institutions, corrective agencies) as SB-organizations to accord them with the status of being involved in credible and trustworthy social transformation. The ET platform analyses the involvement of entities in various activities in these organizations and increase their SB score based on time, money and effort they invest for social causes. At operation 907, the system may allow entities to launch special interest groups. If a group's subscription grows significantly and the SB score of the group crosses threshold then all the member in that group may have their SB score enhanced. The ET platform restricts the membership to this special group is only to entities that have conformant SB scores so that the group's SB score does not deteriorate.

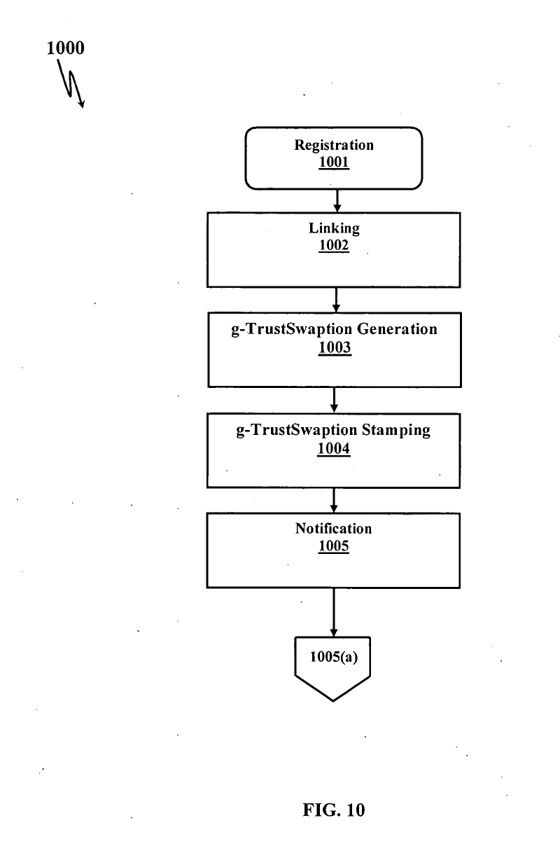

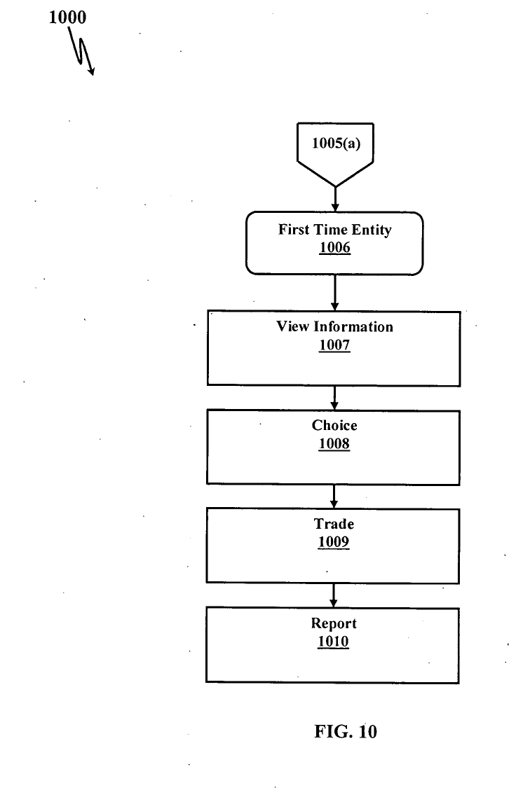

FIG. 10 illustrates a method 1000 for government department registration and linking with public welfare schemes, in accordance with an embodiment. At operation 1001, the government can become registered entity of the system and also can link the government with other government department who may be involved in the transaction. Accordingly, government departments can choose to register on the platform to create programmes/schemes for the citizens. At operation 1002, the government departments can link with citizen welfare and create pubic schemes on the ET platform. Further, the government departments can enroll the beneficiaries of the system by entering their contact details. At operation 1003, the system may generate g-TrustSwaptions worth the value of the scheme or based on the programme defined by government department. At operation 1004, the system may stamp the g-TrustSwaptions with the sender and receiver details. At operation 1005, the system may send notifications (email, SMS) to the recipient of g-TrustSwaptions received from the government department. At operation 1006, the first time entity may require to download the application in their user interface device and subscribe to the service to view the benefits. At operation 1007, the system may provide information to the entities which may include 1) public beneficiary scheme and their benefits from the government (as g-TrustSwaptions) 2) SB score of the entities and the corresponding exchange rate that is applicable to them as part of their SB score. At operation 1008, the receiver can choose one among the two options. At operation 1009, the receiver can either trade their awarded g-TrustSwaptions to repay federal debt or use the g-TrustSwaptions to bid for a restricted pool of offers. At operation 1010, the system may generate reports for total spend utilized, debt repaid, swap for offers, and this marks the end of this process.

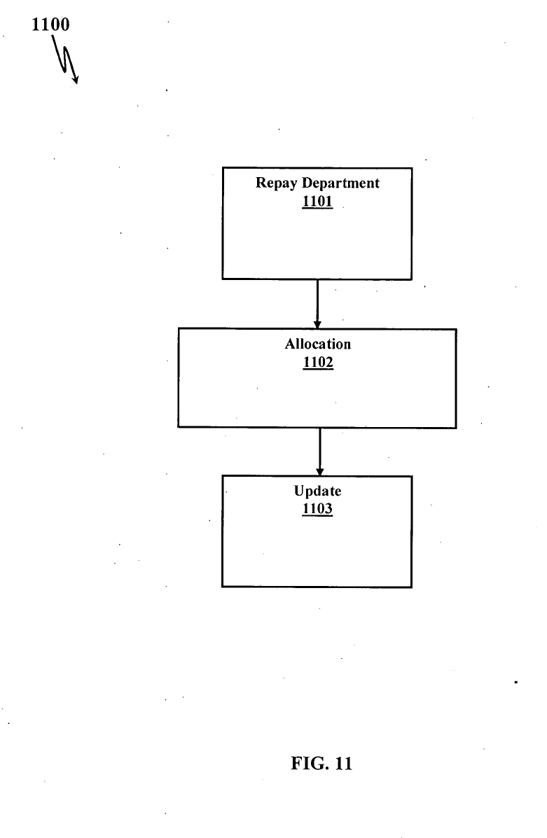

FIG. 11 illustrates a flowchart showing a method 1100 of debt setting process with another government department, in accordance with an embodiment, wherein the system allow the entity who receives g-TrustSwaptions to trade with another government department to repay debts. For example, credits received from one government department can be used to pay the dues for another government department. At operation 1101, the system may identify the receiver's debt with another government department and can give option to entities to repay the debt through the credited g-TrustSwaptions. At operation 1102, the receiver of g-TrustSwaption may require to allocate the amount of g-TrustSwaptions which should go towards repayment depending on the need. At operation 1103, the entities who promptly repay their federal debts are rewarded with improved SB Scores and the system may provide them with ET-TrustSwaptions which can be used for other trading purpose.

In accordance with the present invention, the main advantage is that the merchant can evaluate a consumer's inclination or intention to purchase, social standing, that can enable to build a long term relationship between both the entities. According to present invention, the merchant can circulate or campaign a specific offer to a targeted group of individuals who are highly inclined to transact favorably or extend the offer to other parties of similar interest, and also enables to accurately measure the effectiveness of a campaign in terms of new entity acquisition and repeat purchases. Additionally, the present invention provides a prospective consumer's intent for a product/service offered by a merchant without divulging their personally identifiable information (PII) and also allows entities with specific SB score to bid for offers provided by commercial establishments in a confidential and restricted manner without compromising their PII.

Another advantage of the present invention is that the TrustSwaptions can be used for commercial and non-commercial purposes making it amenable to use by both consumers and philanthropists alike. TrustSwaptions can be used to measure, track, update and manage social standing of a participant entity. Further, the present method enables all participating entities to access their most current individual SB score and it's trending over a period of time, incentivizing them to exhibit socially acceptable behaviors that can lead to improvement in their SB score, thereby all participating entities can assess their current, weighted social rating across all the entities in the system.

Yet another advantage is that the present invention allows a entity to request for exclusive offers that belong to another entity, resulting in either lending or gifting of the m-TrustSwaption. This encourages demand and the likelihood of entities sharing their m-TrustSwaptions more freely. Further, it allows a entity to search through the targeted promotional material or m-TrustSwaptions held by a connection without any explicit knowledge or permission from the latter. According to present invention, the system and method can be used to analyze of social behavior of entities, across entity domains, and across all entities in the system, improve of social scores of communities, build aspirations among entities to vie for higher social ratings, allow entities to improve their poor social ratings, and reward exemplary social behavior.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for trust based transactions between entities or group of entities, the method comprising:
inviting one or more entities to register on ET platform;
allowing one or more issuing entities to set at least a campaign and/or contract;
distributing and activating TrustSwaptions to receiving entities;
allowing said receiving entities to redeem said TrustSwaptions; and
measuring said campaign progress and evaluating return of investment from said campaign;
wherein said TrustSwaptions are negotiable instruments which grant ownership of said instruments without the obligation to enter into an underlying trade and allow said entities to transact among each other; wherein said ET platform captures transactions patterns exhibited by said entities during transactions using said TrustSwaptions to establish and build trustworthiness quotient of said entities.

2. The method as claimed in claim 1, wherein said campaign includes products and/or services, offers, and total value of the campaign.

3. The method as claimed in claim 1, wherein said issuing entities are merchants and government departments, wherein said receiving entities are prospects, consumers and contractors.

4. The method as claimed in claim 3, wherein receiving entities can trade said TrustSwaptions for the purchase of exclusive products and/or services from said issuing entities.

5. The method as claimed in claim 3, wherein said receiving entities are allowed to perform at least one action of TrustSwaptions from a group of action comprises of gifting, donating, sharing, lending, borrowing, exchanging, bidding, and repaying.

6. The method as claimed in claim 5, wherein said receiving entities are allowed to gift said TrustSwaptions to at least another receiving entity, and/or for social causes.

7. The method as claimed in claim 5, wherein said receiving entities are allowed to lend said TrustSwaptions to at least another receiving entity.

8. The method as claimed in claim 1, wherein said trustworthiness quotient of entities is SB score, wherein said SB score of entities is calculated based transactions of the entities, preferably at least a transaction of TrustSwaptions from a group transaction includes issuance, gifting, donating, sharing, lending, borrowing, exchanging, bidding, repaying and proposed time completing.

9. The method as claimed in claim 1, wherein said campaign upon reaching expiry date, said expired TrustSwaptions is entered into an open pool, wherein said entities can bid for said expired TrustSwaptions.

10. The method as claimed in claim 3, wherein said TrustSwaptions includes m-TrustSwaptions, g-TrustSwaptions, and ET-TrustSwaptions, wherein said merchants distributes said m-TrustSwaptions to current and potential consumers, wherein said government distributes said g-TrustSwaptions to consumers and/or merchants, wherein said ET platform credits said ET-TrustSwaptions to the participating entities account based on transactions involving exercise of said TrustSwaptions.

11. The method as claimed in claim 11, wherein said ET-TrustSwaptions in said entities account is equal to said credited ET-TrustSwaptions multiplied by an exchange rate, wherein said exchange rate is derived from said entity's SB score.

12. The method as claimed in claim 11, wherein said consumers can exercise the value of said g-TrustSwaptions for specific product and/or service purchases from said government and/or to receive cash by trading g-TrustSwaptions at banks.

13. A system for trust based transactions between entities or group of entities, the system comprising
at least a user interface device, a database, and an application server including an ET engine, wherein said ET engine comprising
a registration module configured to invite entities to register on ET platform using said user interface device;
a TrustSwaptions exchange and management module configured to create and distribute TrustSwaptions to the entities, and to allow said entities to exercise, gift, donate, share, lend, borrow, exchange, bid the said TrustSwaptions;
an SB score calculator module configured to calculate the SB score of entities based on transactions of said entities, preferably at least a transaction of TrustSwaptions from a group transaction includes issuance, gifting, donating, sharing, lending, borrowing, exchanging, bidding, repaying and proposed time completing;
an exchange rate identifier module configured to identify exchange rate of entities based on SB score of entities; and
a campaign management module configured to create a campaign with product and/or service collateral, define the total value of the campaign, define the total number of consumers to target with TrustSwaptions, upload the contact details of consumers to whom the TrustSwaptions are to be distributed.

14. The system as claimed in claim 13 further comprising a bid management module configured to allow all registered entities to ‘bid’ for specific offers in the OPEN POOL, wherein said offers includes unused or expired m-TrustSwaptions.

15. The system as claimed in claim 14 further comprising
a notification module configured to notify consumers regarding campaign and/or programmes, the received TrustSwaptions;
an OTP transaction module configured to create a unique OTP code for sending to both issuing entities and receiving entities, at the moment redeeming the TrustSwaptions for purchase of product and/or service and/or offer;
a reporting module configured to generate report about data at the end of the campaign for ROI, and data related to repeat purchases, SB score, new entities acquired and interest in the open pool for offer;
a search module configured to allow searching for products and/or services on the ET platform and identify other connected entities who have unused m-TrustSwaptions relevant for the purpose; and
a link module configured to enable entities to establish and manage connections, associate certain number of TrustSwaptions with each connected entity, associate search for specific offers with specific entities, associate SB scores with the entities, associate the TrustSwaptions with the current owners and previous owners and maintain the history of TrustSwaptions movements between entities.

16. The system as claimed in claim 13, wherein said user interface device facilitates transmitting and receiving data over a network, wherein an ET portal and/or application running on user interface device can permit entities to interact with said ET engine.

17. The system as claimed in claim 16, wherein said user interface device includes computer, smart phone, laptop, and tablet.

18. The method as claimed in claim 1, wherein said distribution TrustSwaptions includes converting loyalty schemes or vouchers issued by entities to their customers.
